(19) United States
(12) Patent Application Publication
(10) Pub. No.: US 2025/0072330 A1
(43) Pub. Date: Mar. 6, 2025

(54) SYSTEM AND METHOD FOR AGRICULTURAL VEHICLE

(71) Applicants: CNH Industrial Brasil Ltda., Bairro Vale do Sereno (BR); CNH Industrial Belgium N.V., Zedelgem (BE)

(72) Inventors: João Augusto Marcolin Lucca, Piracicaba (BR); André Satoshi Seki, Sorocaba (BR); Rafael Gazeta de Oliveira, Piracicaba (BR); Bart M.A. Missotten, Zedelgem (BE)

(21) Appl. No.: 18/823,500

(22) Filed: Sep. 3, 2024

(30) Foreign Application Priority Data
Sep. 4, 2023 (BR) 10 2023 017870 7

(51) Int. Cl. A01D 75/18; A01D 45/10; A01F 29/12

(52) U.S. Cl. CPC A01D 75/187; A01D 45/10; A01F 29/12

(57) ABSTRACT

A system for removing debris from an agricultural harvester is provided herein. The system includes a chopper assembly configured to receive and process crop material. The chopper assembly can define an outlet through which a stream of processed crop material is discharged from the chopper assembly. The outlet defines an outlet vertical height and a center point of the outlet. A splitter is positioned downstream of the chopper assembly. The splitter at least partially extends within the stream of processed crop material discharged from the chopper assembly and is positioned above the center point of the outlet.

### CROSS-REFERENCE TO RELATED APPLICATION

This application claims priority to Brazil Patent Application No. 10 2023 017870 7, filed Sep. 4, 2023, and entitled “SYSTEM AND METHOD FOR AGRICULTURAL VEHICLE”, which is hereby expressly incorporated herein by reference in its entirety.

### FIELD

The present disclosure generally relates to systems for improved debris removable for agricultural harvesters, such as sugar cane harvesters.

### BACKGROUND

Several models of agricultural vehicles and equipment include one or more extractors within which air is drawn through a stream of harvested crops, such as a stream of sugar cane billets, to separate and remove pieces of debris or trash from the crops. For example, a primary extractor may be positioned near an intake of an elevator that conveys crops toward a receiver collecting the crops, while a secondary extractor may be positioned near a discharge of the elevator. The primary extractor can be located downstream of the harvester's chopper assembly such that the stream of processed crop material expelled from the chopper assembly flows into a debris extraction chamber defined by the extractor housing. An extractor fan located above the stream of processed crop material within the housing is configured to draw air through the stream to suck debris or trash upwardly and out of the top of the extractor, thereby allowing the heavier crop (e.g., sugar cane billets) to fall downwardly to the intake of the elevator for delivery to the associated receiver.

Accordingly, a system and method for removing debris from an agricultural harvester that allows for improved airflow through the harvester's extractor would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for removing debris from an agricultural harvester. The system includes a chopper assembly configured to receive and process crop material. The chopper assembly definiens an outlet through which a stream of processed crop material is discharged from the chopper assembly. The outlet defines an outlet vertical height and a center point of the outlet. A splitter is positioned downstream of the chopper assembly. The splitter at least partially extends within the stream of processed crop material discharged from the chopper assembly and positioned above the center point of the outlet.

In some aspects, the present subject matter is directed to a method of operating a harvester. The method includes discharging a processed crop material from an outlet of a chopper assembly. The processed crop material defines a first portion in a first region relative to the outlet and a second portion in a second region relative to the outlet. The first region is positioned above the second region. The method also includes separating a flow of the processed crop material in the first region into a first flow of material and a second flow of material into an extraction chamber of an extractor with a splitter.

In some aspects, the present subject matter is directed to an agricultural harvester that includes a chopper assembly configured to receive and process crop material. The chopper assembly defines an outlet through which a stream of processed crop material is discharged from the chopper assembly. An extractor is positioned downstream of the chopper assembly. The extractor includes a housing defining an extraction chamber. The extraction chamber is configured to receive the stream of processed crop material discharged from the chopper assembly. A splitter at least partially extends within the stream of processed crop material flowing between the chopper assembly and the extraction chamber. The splitter is positioned above a center point of the outlet.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic side view of an agricultural vehicle for the harvesting of tall and stalky vegetable crops, such as sugarcane and sorghum, in accordance with aspects of the present subject matter;

FIG. 2 illustrates a schematic side view of a portion of the agricultural harvester shown in FIG. 1;

FIG. 3 illustrates a perspective side view of a splitter suitable for use within a system for removing debris from the agricultural harvester in accordance with aspects of the present subject matter;

FIG. 4 is a bottom perspective view of the system for removing debris from the agricultural harvester in accordance with aspects of the present subject matter;

FIG. 5 illustrates a side view of the system for removing debris from the agricultural harvester in accordance with aspects of the present subject matter;

FIG. 6 is a top schematic view of a chopper assembly, the system, and an extraction chamber defined by an extractor housing of a primary extractor in accordance with aspects of the present subject matter;

FIG. 7 is a flow diagram of a method of operating a harvester in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product through a system. For example, “upstream” refers to the direction from which an agricultural product moves, and “downstream” refers to the direction to which the agricultural product moves. The term “selectively” refers to a component's ability to operate in various states (e.g., an ON state and an OFF state) based on manual and/or automatic control of the component.

The terms “fore” and “aft” refer to relative positions along the agricultural vehicle relative to a fore-aft axis. The fore direction is a direction along the fore-aft axis that may also be referred to as a forward motion direction of the vehicle. In addition, an aft direction along the fore-aft is a direction along the fore-aft axis that may also be referred to as a rearward motion direction of the vehicle. A lateral direction may be defined by a transverse axis that extends between a right side and a left side of the vehicle and may be perpendicular to the fore-aft axis. As such, any component that is “laterally inward” of another component may be positioned in closer proximity to the fore-aft axis, and any component that is “laterally outward” of another component may be positioned in closer proximity to the fore-aft axis along the transverse axis. A longitudinal direction may be defined as a third direction in a three-dimensional plane that is perpendicular to the fore-aft axis and the transverse axis. For example, the height of the vehicle may be defined in the longitudinal direction.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value or the precision of the methods or apparatus for constructing or manufacturing the components and/or systems. For example, the approximating language may refer to being within a ten percent margin.

Moreover, the technology of the present application will be described in relation to examples. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for an agricultural harvester. In some instances, the system can include a chopper assembly configured to receive and process crop material. The chopper assembly can define an outlet through which a stream of processed crop material is discharged from the chopper assembly.

An extractor can be positioned downstream of the chopper assembly. The extractor can include a housing defining an extraction chamber. The extraction chamber can be configured to receive the stream of processed crop material discharged from the chopper assembly.

A splitter can at least partially extend within the stream of processed crop material flowing between the chopper assembly and the extraction chamber. In some cases, the splitter may be positioned above a center point of the outlet of the chopper assembly causing the splitter to interact more with the debris than the billets as the debris is generally lighter in weight than the billets. As such, the splitter, in various instances, can allow for an increase in the airflow through the chamber. The increased airflow may, in turn, improve the cleaning efficiency of the extractor, which may, for example, allow the harvester to accommodate increased throughput. As a result, the splitter may cause minimal to no impact on billet a throwing path, increase the usage of cleaning chamber area for air passage, cause less billets to impact air movement on the side areas of the chamber, allow for better cleaning, and/or reduce fan rotation speeds.

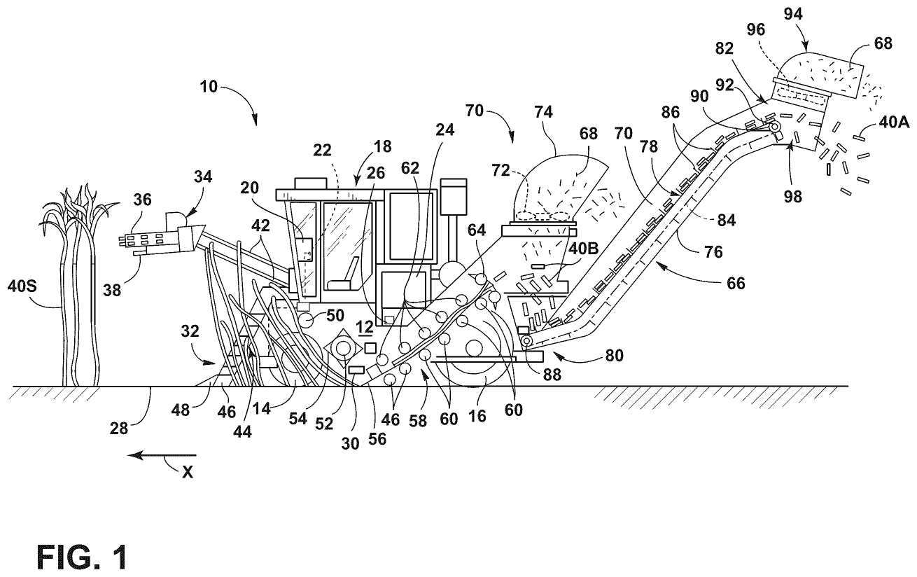

Referring now to the drawings, FIG. 1 illustrates a side view of an agricultural vehicle 10 in accordance with aspects of the present subject matter. As shown, the vehicle 10 is configured as a sugarcane harvester. However, in other embodiments, the vehicle 10 may be configured as any other suitable agricultural harvester or work vehicle.

As shown in FIG. 1, the vehicle 10 can include a frame 12, a pair of front wheels 14, a pair of rear wheels 16, and an operator's cab 18 or any other form of operator's station for permitting the operator to control the operation of the vehicle 10. As illustrated in the example shown in FIG. 1, the vehicle 10 may include a human-machine interface (HMI) 20 for displaying information (e.g., messages and/or alerts) to the operator and/or for allowing the operator to interface with various systems and components of the vehicle 10.

The HMI 20 may also receive a user input through one or more input devices 22 (e.g., levers, pedals, control panels, buttons, and/or the like) within the cab 18 and/or in any other practicable location. In some cases, the HMI 20 can include a pair of displays, and the information provided on each display may be altered based on various vehicle conditions. The information provided may include operational information that may impact harvesting performance, which may be presented on a clear interface with minimal visual pollution for the operator or another individual. Additionally, or alternatively, the HMI 20 may provide support information that can include a vehicle information, such as vehicle status, vehicle maintenance, and/or the like, that may be intermittently monitored by the operator or another individual.

The vehicle 10 may also include a power source 24 (e.g., an engine mounted on the frame 12) that powers one or both pairs of the wheels 14, 16 via a driveline assembly 26 (e.g., a transmission) to traverse a field 28. Alternatively, the vehicle 10 may be a track-driven vehicle and, thus, may include tracks driven by the power source 24 as opposed to the illustrated wheels 14, 16. The power source 24 may also drive a hydraulic fluid pump 30 configured to generate pressurized hydraulic fluid for a hydraulic circuit, which may be configured to power various components of the vehicle 10, including the driveline assembly 26.

The vehicle 10 may also include a crop processing system 32 incorporating various components, assemblies, and/or sub-assemblies of the vehicle 10 for cutting, processing, cleaning, and discharging sugarcane as the cane is harvested from an agricultural field 28. For instance, the crop processing system 32 may include a topper assembly 34 positioned at the front end portion of the vehicle 10 to intercept sugarcane as the vehicle 10 is moved in a forward direction. As shown, the topper assembly 34 may include both a gathering disk 36 and a cutting disk 38. The gathering disk 36 may be configured to gather the sugarcane stalks 40S so that the cutting disk 38 may be used to cut off the top of each stalk 40S. As is generally understood, the height of the topper assembly 34 may be adjustable via a pair of arms 42, which may be hydraulically raised and lowered.

The crop processing system 32 may further include a crop divider 44 that extends upwardly and rearwardly from the field 28. In general, the crop divider 44 may include one or more spiral feed rollers 46. Each feed roller 40 may include a ground shoe 48 at its lower end portion to assist the crop divider 44 in gathering the sugarcane stalks 40S for harvesting. Moreover, as shown in FIG. 1, the crop processing system 32 may include a knock-down roller 50 positioned near the front wheels 14 and a fin roller 52 positioned behind the knock-down roller 50. As the knock-down roller 50 is rotated, the sugarcane stalks 40S being harvested are knocked down while the crop divider 44 gathers the stalks 40S from agricultural field 28. Further, as shown in FIG. 1, the fin roller 52 may include a plurality of intermittently mounted fins 54 that assist in forcing the sugarcane stalks 40S downwardly. As the fin roller 52 is rotated during the harvest, the sugarcane stalks 40S that have been knocked down by the knock-down roller 50 are separated and further knocked down by the fin roller 52 as the vehicle 10 continues to be moved in the forward direction relative to the field 28.

Referring still to FIG. 1, the crop processing system 32 of the vehicle 10 may also include a base cutter assembly 56 positioned behind the fin roller 52. The base cutter assembly 56 may include blades for severing the sugarcane stalks 40S as the cane is being harvested. Additionally, in several embodiments, the blades may be angled downwardly to sever the base of the sugarcane as the cane is knocked down by the fin roller 52.

Moreover, the crop processing system 32 may include a feed roller assembly 58 located downstream of the base cutter assembly 56 for moving the severed stalks 40S of sugarcane from base cutter assembly 56 along the processing path of the crop processing system 32. As shown in FIG. 1, the feed roller assembly 58 may include a plurality of bottom rollers 60 and a plurality of opposed top rollers 62. The various bottom and top rollers 60, 62 may be used to pinch the harvested sugarcane during transport. As the sugarcane is transported through the feed roller assembly 58, debris 68 (e.g., rocks, dirt, and/or the like) may be allowed to fall through bottom rollers 60 onto the field 28.

In addition, the crop processing system 32 may include a chopper assembly 64 located at the downstream end section of the feed roller assembly 58 (e.g., adjacent to the rearward-most bottom roller 60 and the rearward-most top roller 62). In general, the chopper assembly 64 may be used to cut or chop the severed sugarcane stalks 40S into pieces or “billets” 40B, which may be, for example, six (6) inches long. The billets 40B may then be propelled towards an elevator assembly 66 of the crop processing system 32 for delivery to an external receiver or storage device.

The pieces of debris 68 (e.g., dust, dirt, leaves, etc.) separated from the sugarcane billets 40B may be expelled from the vehicle 10 through a primary extractor 70 of the crop processing system 32, which may be located downstream of the chopper assembly 64 and may be oriented to direct the debris 68 outwardly from the vehicle 10. Additionally, an extractor fan 72 may be mounted within an extractor housing 74 of the primary extractor 70 for generating a suction force or vacuum sufficient to force the debris 68 through the primary extractor 70. The separated or cleaned billets 40B, which may be heavier than the debris 68 expelled through the extractor 70, may then fall downward to the elevator assembly 66.

As shown in FIG. 1, the elevator assembly 66 may include an elevator housing 76 and an elevator 78 extending within the elevator housing 76 between a lower, proximal end portion 80 and an upper, distal end portion 82. In some examples, the elevator 78 may include a looped chain 84 and a plurality of flights or paddles 86 attached to and spaced on the chain 84. The paddles 86 may be configured to hold the sugarcane billets 40B on the elevator 78 as the sugarcane billets 40B are elevated along a top span of the elevator 78 defined between its proximal and distal end portions 80, 82. Additionally, the elevator 78 may include lower and upper sprockets 88, 90 positioned at its proximal and distal end portions 80, 82, respectively. As shown in FIG. 1, an elevator motor 92 may be coupled to one of the sprockets (e.g., the upper sprocket 90) for driving the chain 84, thereby allowing the chain 84 and the paddles 86 to travel in a loop between the proximal and distal end portions 80, 82 of the elevator 78.

Moreover, in some embodiments, pieces of debris 68 (e.g., dust, dirt, leaves, etc.) separated from the elevated sugarcane billets 40B may be expelled from the vehicle 10 through a secondary extractor 94 of the crop processing system 32 coupled to the rear end portion of the elevator housing 76. For example, the debris 68 expelled by the secondary extractor 94 may be debris 68 remaining after the billets 40B are cleaned and debris 68 expelled by the primary extractor 70. As shown in FIG. 1, the secondary extractor 94 may be located adjacent to the distal end portion 82 of the elevator 78 and may be oriented to direct the debris 68 outwardly from the vehicle 10. Additionally, an extractor fan 96 may be mounted at the base of the secondary extractor 94 to generate a suction force or vacuum sufficient to force the debris 68 through the secondary extractor 94. The separated, cleaned billets 40B, heavier than the debris 68 expelled through the primary extractor 70, may then fall from the distal end portion 82 of the elevator 78. In some instances, the billets 40B may fall through an elevator discharge opening 98 defined by the elevator assembly 66 into an external storage device, such as a sugarcane billet cart.

During operation, the vehicle 10 traverses the agricultural field 28 for harvesting sugarcane. After the height of the topper assembly 34 is adjusted via the arms 42, the gathering disk 36 on the topper assembly 34 may function to gather the sugarcane stalks 40S as the vehicle 10 proceeds across the field 28, while the cutting disk 38 severs the leafy tops of the sugarcane stalks 40S for disposal along either side of the vehicle 10. As the stalks 40S enter the crop divider 44, the ground shoes 48 may set the operating width to determine the quantity of sugarcane entering the throat of the vehicle 10. The spiral feed rollers 46 then gather the stalks 40S into the throat to allow the knock-down roller 50 to bend the stalks 40S downwardly in conjunction with the action of the fin roller 52. Once the stalks 40S are angled downward, as shown in FIG. 1, the base cutter assembly 56 may then sever the base of the stalks 40S from the field 28. The severed stalks 40S are then, by the movement of the vehicle 10, directed to the feed roller assembly 58.

The severed sugarcane stalks 40S are conveyed rearwardly by the bottom and top rollers 60, 62, which compresses the stalks 40S, makes them more uniform, and shakes loose debris 68 to pass through the bottom rollers 60 to the field 28. At the downstream end portion of the feed roller assembly 58, the chopper assembly 64 cuts or chops the compressed sugarcane stalks 40S into pieces or billets 40B (e.g., 6-inch cane sections). The processed crop discharged from the chopper assembly 64 is then directed as a stream of billets 40B and debris 68 into the primary extractor 70. The airborne debris 68 (e.g., dust, dirt, leaves, etc.) separated from the billets 40B is then extracted through the primary extractor 70 using suction created by the extractor fan 72. The separated/cleaned billets 40B then be directed to an elevator hopper into the elevator assembly 66 and travel upwardly via the elevator 78 from its proximal end portion 80 to its distal end portion 82. During normal operation, once the billets 40B reach the distal end portion 82 of the elevator 78, the billets 40B fall through the elevator discharge opening 98 to an external storage device. If provided, the secondary extractor 94 (with the aid of the extractor fan 96) blows out trash/debris 68 from the vehicle 10, similar to the primary extractor 70.

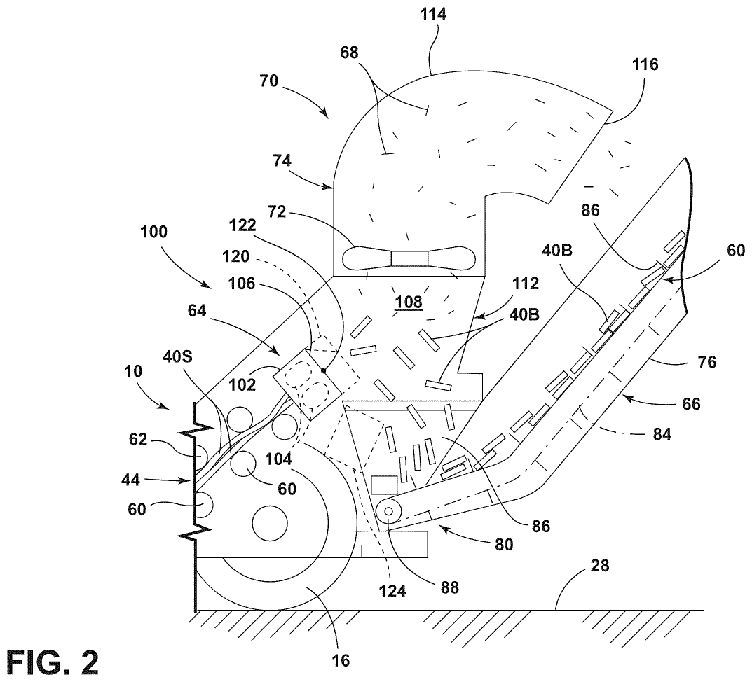

Referring now to FIG. 2, a side view of a portion of the agricultural vehicle 10 shown in FIG. 1 is illustrated, particularly illustrating various components of a system 100 for removing debris 68 from a harvester in accordance with aspects of the present subject matter. For purposes of discussion, the system 100 will generally be described herein with reference to the embodiment of the vehicle 10 shown in FIG. 1. However, it should be appreciated that aspects of the disclosed system 100 may be incorporated into a harvester having some other suitable configuration.

In several examples, the system 100 may include one or more of the harvester components described above with reference to FIG. 1, such as the chopper assembly 64 and/or the primary extractor 70. As shown in FIG. 2, the chopper assembly 64 may generally include a housing 102 and one or more chopper elements 104 (e.g., a pair of chopper drums) rotatably supported within the chopper housing 102. In various examples, the chopper elements 104 can be configured to be rotatably driven within the housing 102 to cut or chop the harvested crop material received from the feed roller assembly 58, thereby generating a stream of processed crop material (e.g., including both billets 40B and debris 68) that is discharged from the chopper assembly 64 via an outlet 106 defined by the housing 102. The stream of processed crop material expelled from the outlet 106 of the chopper assembly 64 then flows into an extraction chamber 108 defined by an extractor housing 74 of the primary extractor 70, through which an airflow is generated (e.g., via the extractor fan 72) to separate the debris 68 from the billets 40B. As shown in FIG. 2, the extractor housing 74 may include both a lower housing portion 112 and an upper housing portion 114 (also referred to as an extractor hood), with the lower housing portion 112 being generally positioned relative to the chopper assembly 64 such that the stream of processed crop material discharged from the chopper assembly 64 is received within the portion of the extraction chamber 108 defined by the lower housing portion 112. The debris 68 separated from the billets 40B within the extraction chamber 108 then flows upwardly through the upper housing portion 114 and is expelled from the extractor 70 via an outlet 116 of the extractor housing 74.

Additionally, the system 100 may also include a splitter 120 positioned at or adjacent to the outlet 106 of the chopper assembly 64. In some cases, the splitter 120 may be positioned above a center point 122 of the outlet 106 of the chopper assembly 64 causing the splitter 120 to interact more with the debris 68 than the billets 40B as the debris 68 is generally lighter in weight than the billets 40B. As such, the splitter 120, in various instances, can allow for an increase in the airflow through the chamber 108. The increased airflow may, in turn, improve the cleaning efficiency of the extractor 70, which may, for example, allow the vehicle 10 to accommodate increased throughput.

Moreover, in various examples, the vehicle 10 may also include an optional secondary fan assembly 124 positioned below the stream of crop material discharged from the chopper assembly 64 to direct a supplemental flow of air A through the processed crop material to further facilitate separation of the debris 68 from the billets 40B for removal by the extractor 70. For example, as shown in FIG. 2, the secondary fan assembly 124 may be located adjacent to the outlet 106 of the chopper assembly 64, such as at a location below the deflector assembly. In such an example, the fan assembly 124 may be oriented to blow the stream of air A through the split flows of crop material downstream of the splitter 120 in the direction of the upper housing portion 114. As previously described, the debris 68 extracted by the extractor 70 is then directed out of and away from vehicle 10, e.g., through the outlet 116 of the upper housing portion 114.

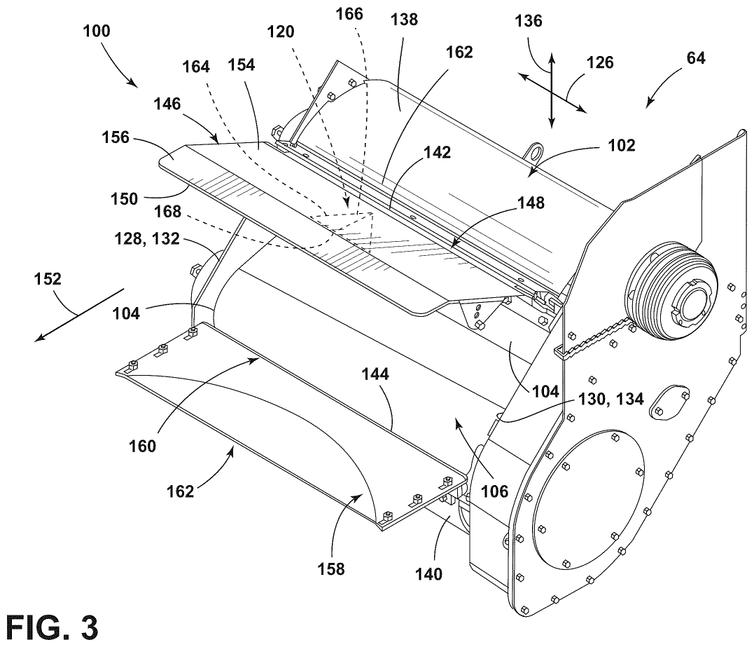

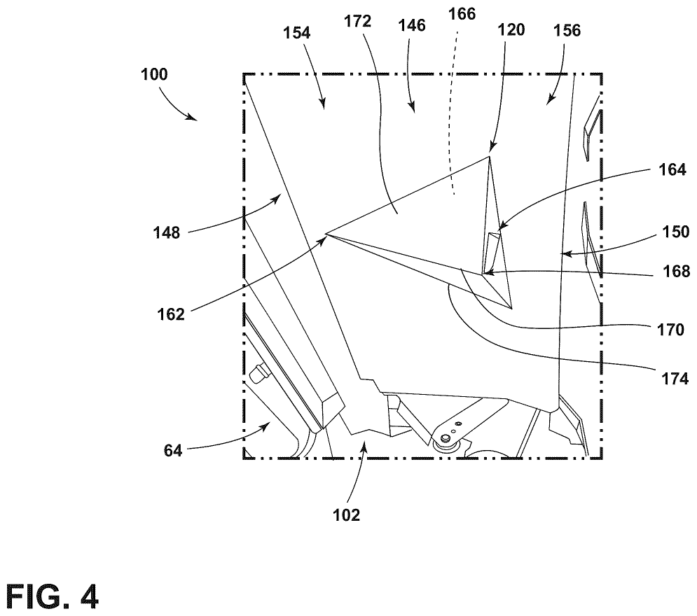

Referring now to FIGS. 3-6, differing views of various examples of components suitable for use within the system 100 described above are illustrated in accordance with aspects of the present subject matter.

As indicated above, the chopper assembly 64 may include a chopper housing 102, with the outlet 106 of the chopper assembly 64 being formed by an opening defined through an aft or rearward end portion of the housing 102. For example, as shown in FIG. 3, the outlet 106 is defined in a lateral direction (indicated by arrow 126) between opposed first and second sidewalls 128, 130 of the chopper housing 102 such that the sidewalls 128, 130 defined respective first and second lateral sides 132, 134 of the outlet 106. In such an example, the lateral sides 132, 134 of the outlet 106 defined by opposed sidewalls 128, 130 of the housing 102 may generally define lateral flow boundaries of the processed crop material discharged from the chopper assembly 64. Additionally, as shown in FIG. 3, the outlet 106 is defined in a vertical direction (indicated by arrow 136) between opposed top and bottom housing portions 138, 140 of the chopper housing such that the opposed housing portions 138, 140 define respective top and bottom end portions 142, 144 of the outlet 106. In such an example, the top and bottom end portions 142, 144 of the outlet 106 defined by the opposed housing portions 138, 140 of the chopper housing 102 may generally define vertical flow boundaries of the processed crop material discharged from the outlet 106.

Moreover, in several examples, the system 100 may also include upper and lower walls or plates extending outwardly from the chopper housing 102 at locations adjacent to the top and bottom end portions 142, 144, respectively, of the outlet 106. For instance, as shown in FIGS. 3-5, an upper plate 146 may be supported adjacent to a portion of the chopper housing 102 (e.g., the top housing portion 138) such that the upper plate 146 extends outwardly from the chopper housing 102 adjacent to the top end portion 142 of the outlet 106. For example, as shown in FIG. 3, the upper plate 146 may include an upstream end portion 148 positioned adjacent to the top end portion 142 of the outlet 106 and a downstream end portion 150 spaced apart from the chopper assembly 64 in the direction of flow of the processed crop material (indicated by arrow 152). In such an example, the upper plate 146 may form a continuation of the upper flow boundary defined by the top end portion 142 of the outlet 106 so that crop material expelled from the outlet 106 at its top end portion 142 flows along the upper plate 146 between the plate's upstream and downstream end portions 148, 150. In addition, the upper plate 146 may also function as a deflector plate configured to redirect or deflect the uppermost portions of the stream of processed crop material discharged from the outlet 106. For example, as shown in FIGS. 3-5, the upper plate 146 may include a first angled wall portion 154 and a second angled wall portion 156, each extending between an upstream end portion 148 of the upper plate 146 and a downstream end portion 150 of the upper plate 146. In some cases, the first angled wall portion 154 is non-parallel to the second angled wall portion 156. Moreover, with the first angled wall portion 154 and the second angled wall portion 156 being oriented in a non-parallel orientation (e.g., at differing angles relative to the flow of processed crop material), the stream or processed crop material may be properly diverted into the extraction chamber 108 (FIG. 2) of the extractor housing 74 positioned downstream of the chopper assembly 64.

Referring further to FIGS. 3-5, a lower plate 158 may be supported adjacent to a portion of the chopper housing 102 (e.g., the bottom housing portion 140) such that the lower plate 158 extends outwardly from chopper housing 102 adjacent to the bottom end portion 144 of the outlet 106. For example, as shown in FIG. 3, the lower plate 158 may include an upstream end portion 160 positioned adjacent to the bottom end portion 144 the outlet 106 and a downstream end portion 164 spaced apart from the chopper assembly 64 in the flow direction 126 of the processed crop material. In such an example, the lower plate 158 may form a continuation of the lower flow boundary defined by the bottom end portion 144 of the outlet 106.

As indicated above, the disclosed splitter 120 may be configured to be supported relative to the outlet 106 of the chopper assembly 64 such that the splitter 120 is positioned at least partially within the stream of processed crop material discharged from the chopper assembly 64, thereby allowing the splitter 120 to divert the stream into separate flows of processed crop material. Specifically, in several examples, the splitter 120 may be positioned downstream of the outlet 106 of the chopper assembly 64 at a centralized location relative to the stream of processed crop material, thereby allowing the splitter 120 to divert the processed crop material away from the center of the downstream extraction chamber 108 (FIG. 2) as the divided streams of material flow into the extractor housing 74 (FIG. 2). For example, as shown in FIG. 3-5, the splitter 120 may be positioned relative to the chopper assembly 64 in the lateral direction 126 to be aligned with the center of the outlet 106 defined between the opposed sidewalls 128, 130 of the chopper housing 102. Moreover, the splitter 120 can at least partially extend within the stream of processed crop material discharged from the chopper assembly 64 and be positioned above the center point 122 of the outlet 106.

In general, the splitter 120 may have any suitable configuration and may be configured as any suitable member or component that allows the splitter 120 to function as a flowing splitting device when the splitter 120 is positioned within the stream of processed crop material discharged from the chopper assembly 64. For example, in several examples, the splitter 120 may be configured as an oblique pyramid structure. In such instances, the splitter 120 can include an upstream end section 162 and a downstream end section 164. A base section 166 of the splitter 120 may be operably coupled with the upper plate 146. Further, in some examples, the base section 166 may be coupled with the first angled wall portion 154 of the upper plate 146. In some instances, the base section 166 may terminate upstream of the second angled wall portion 156.

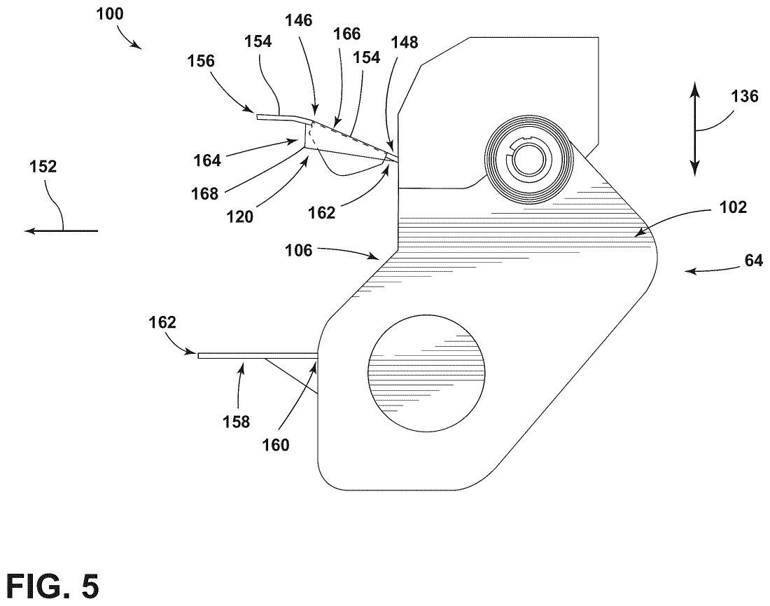

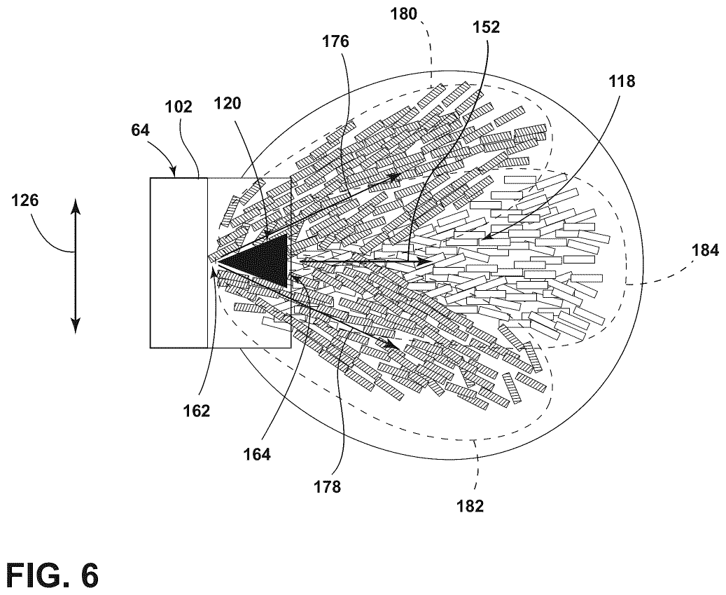

In several examples, an apex section 168 of the splitter 120 may be positioned proximate to the downstream end section 164 of the splitter 120. In various instances, the apex section 168 may be positioned upstream of the second angled wall portion 156. In some instances, a lateral edge 170 may be defined between the upstream end section 162 and the apex section 168. First and second lateral side sections 172, 174 may be positioned on opposing sides of the lateral edge 170 and the base section 166. In such an example, the stream of processed crop material discharged from the outlet 106 (e.g., as indicated by arrow 145 in FIG. 6) may initially generally separate based on the weight of the various components thereof. For instance, the billets 40B may be positioned below the debris 68 based on a difference in weight between the two types of crop material. During use, some of the crop material may contact or encounter the upstream end section 162 of the splitter 120, which, in turn, may divide that portion of the processed crop material into two separate flows of material (e.g., as indicated by arrows 176 and 178 in FIG. 5). Each separate material flow 176, 178 may then be directed along the adjacent first lateral side section 172 and second lateral side section 174 of the splitter 120 such that the processed crop material is diverted along diverging flow paths as the material flows past the splitter 120 and into the downstream extraction chamber 108 (FIG. 2) of the extractor housing 74. As a result, a pair of lateral zones 180, 182 may include a higher concentration of debris 68 than billets 40B, while a central zone 184 (in a lateral direction as indicated by arrow 126) may include a higher concentration of billets 40B than debris 68. The three laterally offset zones may provide for increased airflow through the extraction chamber 108, thereby allowing for the cleaning efficiency of the extractor 70 to be improved and/or a rotational speed of the primary extractor fan 72 may be reduced.

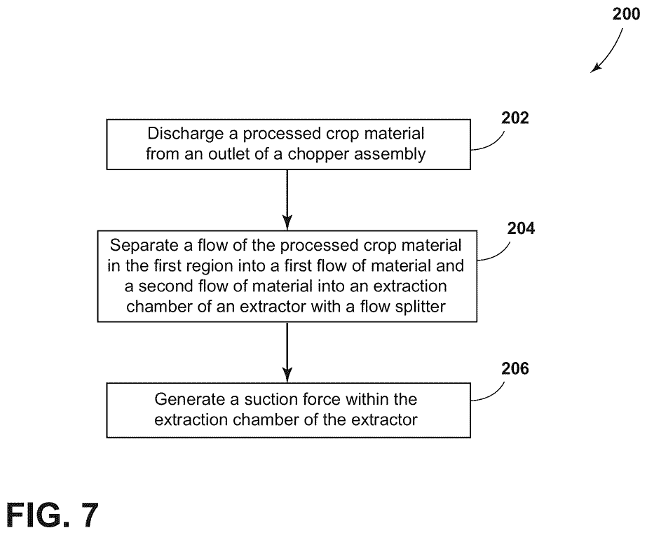

Referring now to FIG. 7, a method 200 of operating a harvester is illustrated in accordance with aspects of the present subject matter. In general, the method 200 will be described herein with reference to the vehicle 10 described above with reference to FIGS. 1-6. However, the disclosed method 200 may generally be utilized with any suitable cutting and harvesting assembly. In addition, although FIG. 7 depicts steps performed in a particular order for purposes of illustration and discussion, the methods discussed herein are not limited to any particular order or arrangement. One skilled in the art, using the disclosure provided herein, will appreciate that various steps of the methods disclosed herein can be omitted, rearranged, combined, and/or adapted in various ways without deviating from the scope of the present disclosure.

As shown in FIG. 14, at (202), the method 200 can include discharging a processed crop material from an outlet of a chopper assembly. As provided herein, the chopper assembly may generally include an outer housing and one or more chopper elements (e.g., a pair of chopper drums) rotatably supported within the chopper housing. In various examples, the chopper elements can be configured to be rotatably driven within the housing to cut or chop the harvested crop material received from the feed roller assembly, thereby generating a stream of processed crop material (e.g., including both billets 40B and debris) that is discharged from the chopper assembly via an outlet defined by the housing. The stream of processed crop material expelled from the outlet of the chopper assembly then flows into an extraction chamber defined by an extractor housing of the primary extractor.

In some examples, the processed crop material can define a first portion in a first region relative to the outlet and a second portion in a second region relative to the outlet. Moreover, the first region can be positioned above the second region, below the second region, and/or vertically aligned with the second region. In instances in which the first region is positioned above the second region, the processed crop material in the first region can include a higher concentration of debris than billets 40B, and the processed crop material in the second region can include a higher concentration of billets 40B than debris.

At (204), the method 200 can include separating a flow of the processed crop material in the first region into a first flow of material and a second flow of material into an extraction chamber of an extractor with a splitter. In some cases, the splitter 120 may be positioned above a center point of the outlet of the chopper assembly causing the splitter to interact more with the debris than the billets 40B as the debris is generally lighter in weight than the billets 40B.

In some examples, the first flow of material flows into a first zone, and the second flow of material diverges into a second zone of a downstream extraction chamber of an extractor housing. In various examples, the first zone can be laterally offset from the second zone. Further, a flow of the processed crop material in the second region is directed into a central zone. In some instances, the central zone can be laterally between the first zone and the second zone.

At (206), the method 200 can include generating a suction force within the extraction chamber of the extractor (e.g., via the extractor fan) to separate the debris from the billets 40B.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for removing debris from an agricultural harvester, the system comprising:
a chopper assembly configured to receive and process crop material, the chopper assembly defining an outlet through which a stream of processed crop material is discharged from the chopper assembly, wherein the outlet defines an outlet vertical height and a center point of the outlet; and
a splitter positioned downstream of the chopper assembly, the splitter at least partially extending within the stream of processed crop material discharged from the chopper assembly and positioned above the center point of the outlet.

2. The system of claim 1, further comprising:
an upper plate extending outwardly from the chopper assembly adjacent to a top end portion of the outlet.

3. The system of claim 2, wherein the splitter is operably coupled with the upper plate.

4. The system of claim 2, wherein the upper plate includes a first angled wall portion and a second angled wall portion each extending between an upstream end portion of the upper plate and a downstream end portion of the upper plate, and wherein the first angled wall portion is non-parallel to the second angled wall portion.

5. The system of claim 4, wherein the splitter is positioned downstream of the outlet and upstream of the second angled wall portion.

6. The system of claim 1, wherein the splitter is configured as an oblique pyramid structure.

7. The system of claim 6, wherein the splitter includes an upstream end section and a downstream end section, and wherein an apex section of the oblique pyramid structure may be positioned proximate to the downstream end section of the splitter.

8. The system of claim 7, wherein the splitter further comprises:
a base section operably coupled with an upper plate positioned downstream of the outlet;
a lateral edge may be defined between the upstream end section and the apex section; and
first and second lateral sides positioned on opposing sides of the lateral edge and the base section.

9. The system of claim 1, wherein the splitter is configured to divide at least a portion of processed crop material into two separate flows of material.

10. A method of operating a harvester, the method comprising:
discharging a processed crop material from an outlet of a chopper assembly, the processed crop material defining a first portion in a first region relative to the outlet and a second portion in a second region relative to the outlet, the first region positioned above the second region; and
separating a flow of the processed crop material in the first region into a first flow of material and a second flow of material into an extraction chamber of an extractor with a splitter.

11. The method of claim 10, wherein the processed crop material in the first region includes a higher concentration of debris than billets, and wherein the processed crop material in the second region includes a higher concentration of billets 40B than debris.

12. The method of claim 10, wherein the first flow of material flows into a first zone and the second flow of material diverges into a second zone of a downstream extraction chamber of an extractor housing, the first zone laterally offset from the second zone.

13. The method of claim 12, wherein a flow of the processed crop material in the second region is directed into a central zone, wherein the central zone is laterally between the first zone and the second zone.

14. The method of claim 10, further comprising:
generating a suction force within the extraction chamber of the extractor.

15. The method of claim 10, wherein the splitter is positioned above a center point of the outlet.

16. An agricultural harvester comprising:
a chopper assembly configured to receive and process crop material, the chopper assembly defining an outlet through which a stream of processed crop material is discharged from the chopper assembly;
an extractor positioned downstream of the chopper assembly, the extractor including a housing defining an extraction chamber, the extraction chamber configured to receive the stream of processed crop material discharged from the chopper assembly; and
a splitter at least partially extending within the stream of processed crop material flowing between the chopper assembly and the extraction chamber, the splitter is positioned above a center point of the outlet.

17. The agricultural harvester of claim 16, wherein the splitter is configured as an oblique pyramid structure.

18. The agricultural harvester of claim 17, wherein the splitter includes an upstream end section and a downstream end section, and wherein an apex section of the oblique pyramid structure may be positioned proximate to the downstream end section of the splitter.

19. The agricultural harvester of claim 18, wherein the splitter further comprises:
a base section operably coupled with an upper plate positioned downstream of the outlet;
a lateral edge may be defined between the upstream end section and the apex section; and
first and second lateral sides positioned on opposing sides of the lateral edge and the base section.

20. The agricultural harvester of claim 16, wherein the splitter is configured to divide at least a portion of processed crop material into two separate flows of material.
